(19) United States
(12) Patent Application Publication
(10) Pub. No.: US 2020/0198297 A1
(43) Pub. Date: Jun. 25, 2020

(54) A BODY COMPRISING A CERMET PART AND A METHOD FOR THE MANUFACTURING THEREOF

(71) Applicant: HYPERION MATERIALS & TECHNOLOGIES (Sweden) AB, Stockholm (SE)

(72) Inventors: Jessica Marshall, West Midlands (GB); Gary Sweetman, West Midlands (GB)

(21) Appl. No.: 16/609,899

(22) PCT Filed: Feb. 23, 2018
(86) PCT No.: PCT/EP2018/054582

§ 371 Date: Oct. 31, 2019

(30) Foreign Application Priority Data
May 5, 2017 (EP) 17169649.5

(51) Int. Cl. B32B 9/04; B23K 35/32; B23K 35/30; C22C 1/10; C22C 5/08; C22C 29/06

(52) U.S. Cl. CPC B32B 9/041; B23K 35/327; B23K 35/3006; B23K 2103/04; C22C 5/08; C22C 29/06; C22C 1/1084

(57) ABSTRACT

Provided is a body that includes a cermet part. The cermet part may include a niobium carbide based hard phase and a nickel based metallic binder. Also provided is a method for manufacturing the body.

### TECHNICAL FIELD

The present disclosure relates to a body comprising a cermet part, comprising a niobium carbide based hard phase and a nickel based metallic binder, a method for manufacturing the body and the use of the body for reducing the contact angle of a melted braze.

### BACKGROUND

Cemented carbides based on tungsten carbide (WC) are widely used for many applications where high hardness, transverse rupture strength and high fracture toughness are required. However, the supplies of tungsten carbide are declining and consequently its cost is increasing, therefore alternative hard metals are being considered to find suitable alternatives. Cermets based on niobium carbides (NbC) have the potential to be such an alternative hard material in some applications and have also a plentiful supply and are thus cheaper to purchase.

Additionally, NbC based hard material could be used to replace stainless steel tools in applications which are close to the property limits for stainless steel but where WC based cemented carbide are too expensive.

Brazing is commonly used in the manufacture of cemented carbide and cermet tools to join the cemented carbide or cermet cutting tip to a steel shank or to another piece of cemented carbide or cermet with a different geometry and/or composition. However, for a cermet part containing a niobium carbide based hard phase and a nickel based metallic binder, there is a problem in using brazing methods which are commonly used for cemented carbides comprising tungsten carbide as the contact angle of a melted braze alloy will be greater than 90° meaning that the brazeability of the cermet part is poor and thus a strong joint will not be formed.

The aim of the present disclosure is to provide a solution which will reduce or even eliminate the problems mentioned above.

### SUMMARY

Thus, the present disclosure therefore provides a body comprising:

a cermet part containing a niobium carbide based hard phase and a nickel based metallic binder; a braze alloy; and
at least one other part to which the cermet part is to be brazed to;
characterized in that the cermet part contains at least 0.5 atomic % (at %) molybdenum.

Furthermore, the present disclosure also relates to a method of brazing a cermet part, said cermet part contains a niobium carbide based hard phase and a nickel based metallic binder, to at least one other part, the method comprising the steps of:
a. providing a hard phase powder comprising more than 50 weight % (wt %) niobium carbide based on the total amount of the hard phase powder, such as more than 60 wt % niobium carbide, such as more than 70 wt % niobium carbide, such as more than 80 wt % niobium carbide, such as more than 90 wt % niobium carbide;
b. providing a metallic binder powder comprising more than 50 wt % nickel based of the total amount of the metallic binder powder, such as more than 60 wt % nickel, such as more than 70 wt % nickel, such as more than 80 wt % nickel, such as more than 90 wt % nickel;
c. mixing the hard phase powder and the metallic binder powder with an organic binder to obtain a powder mixture;
d. milling the obtained powder mixture;
e. pressing the milled powder mixture;
f. sintering the pressed powder mixture to obtain a sintered cermet part;
g. providing a braze alloy; and
h. brazing the obtained sintered cermet part to at least one other part by using the braze alloy;

characterized in that in step c. either:

a powder of molybdenum carbide (MoC) is added or

a powder of molybdenum and a powder of carbon are added.

Thus, the present disclosure will provide a method which will make it possible to braze a cermet part containing a niobium carbide based hard phase and a nickel based metallic binder, to at least one other part.

Additionally, the present disclosure also relates to the use of a cermet part, said cermet contains a niobium carbide based hard phase and a nickel based metallic binder and molybdenum for reducing a contact angle of a melted braze when the cermet part is brazed to at least one other part by using the method of brazing the cermet part.

### BRIEF DESCRIPTION OF DRAWINGS

FIG. 1: discloses an annotated optical image of the melted braze alloy on the surface of the cermet showing how the contact angle is measured;

FIG. 2: discloses an optical image of sample A showing the contact angle of the braze;

FIG. 3: discloses an optical image of sample B showing the contact angle of the braze;

FIG. 4: discloses an optical image of sample C showing the contact angle of the braze;

FIG. 5: discloses an optical image of sample D showing the contact angle of the braze;

FIG. 6: discloses an optical image of sample E showing the contact angle of the braze;

FIG. 7: discloses an optical image of sample F showing the contact angle of the braze;

FIG. 8: discloses an optical image of sample G showing the contact angle of the braze;

### DETAILED DESCRIPTION

According to one aspect of the present disclosure there is provided a body comprising;
a cermet part containing a niobium carbide based hard phase and a nickel based metallic binder;
a braze alloy; and
at least one other part to which the cermet part is to be brazed to;
characterized in that the cermet part contains at least 0.5 atomic percent molybdenum.

Atomic percentage for the cermet part is calculated by taking the weight percentages (wt %) of the powders added, then using the respective molecular or atomic weights of the components of the powders added during the manufacture of the cermet part to calculate the relative atomic percentages (at %), for each element. Atomic percent is also known as atomic mol % fraction. For any carbide additions, the amounts have been broken down into their respective wt % fractions of the metal and carbon in order to calculate the atomic percentages of the individual elements.

The term wt % refers to the wt % of the each powder in comparison to the total powder composition. The positive effect of the molybdenum (Mo) addition on the brazeability of the cermet part is only seen if at least 0.5 at % Mo is added.

The inventors have surprisingly found that the addition of the molybdenum will greatly increase the brazeability of the cermet part, as will be seen from the examples. Without being bound by any one theory, it is believed that the added molybdenum will form part of the metallic binder phase and that the addition will make the metallic binder more soluble in the melted braze alloy and therefore a better and stronger braze joint will be formed.

A cermet is defined as being a material comprising a hard phase and a metallic binder phase. In the present disclosure the term “niobium carbide based hard phase” means that the hard phase contains more than 50 wt % niobium carbide particles based on the total amount of hard phase, such as more than 60 wt % niobium carbide, such as more than 70 wt % niobium carbide, such as more than 80 wt % niobium carbide, such as more than 90 wt % niobium carbide. The remaining hard phase will consist of WC, TaC, TiC, ZrC, Mo₂C or HfC or a mixture thereof. Further, in the present disclosure the term “a nickel based metallic binder phase” means that the binder comprises more than 50 wt % nickel based on the total amount of the metallic binder phase, such as more than 60 wt % nickel, such as more than 70 wt % nickel, such as more than 80 wt % nickel, such as more than 90 wt % nickel. The binder may also comprise Co and Fe. It should also be appreciated that the nickel based metallic binder could be replaced with an iron based metallic binder and that small quantities of other carbides such as WC, TiC, TaC, HfC or VC, such as up to about 4 wt %, may be added for example to assist with grain refinement, improving toughness and/or improving hot hardness.

As is well known in the art, brazing is a process used to join or fuse parts comprising hard metal or metal together. During the process, heat is applied to a filler metal, e.g. a braze alloy, which will melt below the melting point of the parts being joined together.

In one embodiment of present disclosure, the cermet part has a molybdenum content of at least 1.0 at % as is shown in the examples, an even more positive effect on the brazeability of the cermet part is seen if the addition of molybdenum is at least 1.0 at %.

In one embodiment of the present disclosure, the molybdenum content of the cermet part is no greater than 10.6 at %, as the properties of the body may be further optimized by keeping the molybdenum addition to no greater than 10.6 at %. When higher quantities of molybdenum are added there is a risk of precipitation of molybdenum carbide. The presence of a second hard phase in the cermet, such as molybdenum carbide, could have a detrimental effect on wear, transverse rupture strength or issues with grain growth control.

In one embodiment, the braze alloy is a silver based braze alloy. In the present disclosure the term “silver based braze alloy” means that the braze alloy contains more than 50 at % silver based on the total amount of the braze alloy. The brazing alloy may comprise, 64 at % Ag, 26 at % Cu, 2 at % Ni, 2 at Mn and 6 at % In.

According to one embodiment, the at least one other part is two or more parts. According to yet another embodiment, at least one of the two parts at least one is a cermet. According to one embodiment of the body as defined herein above or hereinafter, the at least one other part is selected from a cermet, which could have the same composition or have a different composition as the cermet. The at least one other part may be selected from a cemented carbide or a part comprising a steel alloy.

The body may be used in the manufacture of products such as a drill bit, an insert or a saw tip. For example in the case of a drill bit, the working tip of the drill is the cermet part of the body which is brazed to a steel shank (the at least one other part).

Another aspect of the present disclosure relates to a method of brazing a cermet part, which cermet part contains a niobium carbide based hard phase and a nickel based metallic binder, to at least one other part, the method comprising the steps of:
a. providing a hard phase powder comprising more than 50 wt % niobium carbide based on the total amount of the hard phase powder;
b. providing a metallic binder powder comprising more than 50 wt % nickel based of the total amount of the metallic binder powder;
c. mixing the hard phase powder and the metallic binder powder with an organic binder to obtain a powder mixture;
d. milling the obtained powder mixture;
e. pressing the milled powder mixture;
f. sintering the pressed powder mixture to obtain a sintered cermet part; and
g. providing a braze alloy;
h. brazing the obtained sintered cermet part to at least one other part by using the braze alloy;

characterized in that in step c. either:

a powder of molybdenum carbide is added or

a powder of a molybdenum and a powder of carbon are added.

The hard phase powder and the metallic binder powder are milled together with an organic binder typically by using a ball mill. The organic binder is added to aid the pressing and is typically a poly(ethylene glycol) (PEG), such as PEG 34. Typically, then the powder formed into shape by using a pressing method, for example using a TOX press. Then after pressing, the powder mixture is sintered, for example using a Sinter HIP furnace. However, other milling, forming and sintering methods could be employed and other pressing aids could be used for the method of the present disclosure as described herein. As stated herein, the molybdenum is either added in the form of a molybdenum carbide powder or added, in equivalent atomic amounts, as a separate molybdenum powder and a separate carbon powder in step c.

According to one embodiment of the method as defined hereinabove or hereinafter, the weight percent (wt %) of the molybdenum carbide or total weight percent of molybdenum and carbon added is less than the weight percent of nickel of the total powder mixture. The term wt % refers to the wt % of each powder in comparison to the total powder composition, i.e. including the molybdenum carbide addition or the addition of molybdenum and carbon. It was found that if the weight percent of molybdenum carbide or total weight percent of molybdenum and carbon added exceeded the amount of nickel added, precipitations of undissolved molybdenum carbide were present.

According to one embodiment of the method as defined hereinabove or hereinafter, the combined weight percent of the nickel, molybdenum carbide and carbon added is of from 6 to 35 wt %, such as of from 8 to 30 wt % of the total powder mixture. The properties of the cermet part are optimised if the total weight percent of the nickel and molybdenum carbide is at least 6 wt %, such as least 8 wt % in order to form a fully dense cermet. The properties of the cermet are also optimised if the combined weight percent of the nickel, molybdenum carbide and carbon does not exceed 35 wt %, such as no greater than 30 wt %, the because if the metallic binder content in the cermet part is higher than this the contiguity of the material will be reduced, which would have a detrimental effect on the material properties such as a reduction in hardness and toughness.

According to one embodiment of the method as defined hereinabove or hereinafter the braze alloy is silver based.

According to one embodiment of the method as defined hereinabove or hereinafter the at least one other part is selected from a cermet, a cemented carbide or a part comprising a steel.

During the sintering process, molybdenum carbide dissolves in the metallic binder and will be present as molybdenum, rather than molybdenum carbide. If separate molybdenum and carbon powders are added, then both powders would dissolve in the binder. It would appear that in the sintered sample, a nickel-molybdenum based alloy metallic binder and only one hard phase, which is NbC of varying carbon stoichiometries, are formed.

The present disclosure also relates to the use of a cermet part, which cermet part comprises a niobium carbide based hard phase and a nickel based metallic binder and molybdenum for reducing a contact angle of a melted braze alloy when the cermet part is brazed to at least one other part by using a braze alloy. As is understood, a melted braze alloy is a braze alloy in its liquid form. This is achieved by heating the braze alloy to slightly above its melting point temperature. The heating may be performed in a suitable protective atmosphere. The melted braze alloy will flow over the parts to be joined, this is known as wetting, the melted braze alloy and parts are then cooled to join the parts together.

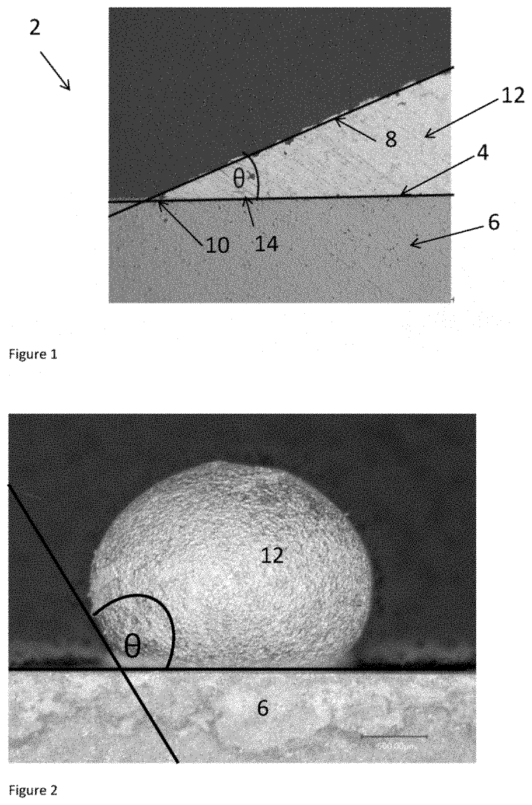

The contact angle, θ, is the angle where the melted braze alloy have contact with the surface upon which it is resting. As shown in FIG. 1, it is measured by taking an optical image of the melted braze on the surface after it has been cooled (2). A first line is drawn (4) along the surface on the cermet (6) and a second line drawn is drawn (8) extending from the contact point with the surface (10) of the melted braze (12). The angle between these two lines is then measured and this is the contact angle (14). A lower contact angle means better wetting of the melted braze alloy and therefore a better joint is achieved between the pieces to be joined. For improved brazeability, it is necessary to be able to reduce the contact angle to the lowest possible angle.

According to one embodiment, the contact angle is reduced to less than 90°, such as less than or equal to 45°, such as less than or equal to 30°. A good wetting is said to have been achieved if the contact angle is less than 90°, if the angle is higher than 90′, then no wetting will occur and the two parts will not be joined together. According to one embodiment, the contact angle is reduced to less than 45°, such as less than 30°. The shallower the contact angle, the larger the surface area of adhesion is and hence the stronger the braze joint obtained is.

According to one embodiment, the melted braze alloy is silver based.

According to one embodiment the at least one other part used is selected from a cermet, a cemented carbide or a part comprising a steel.

The following examples are illustrative, non-limiting examples.

### Examples

Niobium carbide based cermets were prepared by pre-milling the niobium carbide for 20 hours. The pre-milled niobium carbide powder was weighed in, as were the nickel powder and the molybdenum carbide powder. These components were then milled with 1200 g of milling media (cylpebs) with a charge:media mass ratio of 1:21 in ethanol for 8 hours with PEG 34. The obtained powder was then dried, sieved and pressed using the TOX press into pieces with dimensions of approximately 5.5×6.5×20 mm. The pieces were then vacuum sintered at a temperature of between 1410° C. and 1450° C. for 1 hour. The sintered pieces were then coarse ground on a diamond disk and sequentially polished on finer diamond slurries down to the final polish using 1 μm diamond grit with a colloidal silica final stage polish.

For the brazeability trials pieces of 165 μm thick Johnson Matthey Metal Argobraze 64 foil, which is composed of 64 at % Ag, 26 at % Cu, 2 at % Ni, 2 at % Mn, 6 at % In, with a weight of approximately 0.02 g, were placed on the largest face of the sintered sample. The braze alloy was then covered in Johnson Matthey Easy-Flo flux to prevent oxidation. To test the brazeability, the samples were then placed in the centre of a copper coil, the copper coil was made from 2.5 turns of 5 mm diameter copper tubing with an inside diameter of 36 mm which was attached to a 15 kW Ambrel Ekoheat ES induction heater. For each test, the power was set to 100 volts and when turned on the time taken for the braze to melt was approximately 30 seconds. After the melt of the braze was visibly seen by human eye, the power was left on for a further 3 seconds and then switched off. Once the samples had completely cooled, the flux was removed using hot water and then an optical image of the polished cross-section of the melted braze was taken so that the contact angle (8) could be measured.

Table 1 shows a summary of the compositions, as weighed in at the powder mixing stage, the atomic assays and the contact angles measured.

TABLE 1

| | Amounts in weight percent (wt %) | | | | | Amounts in atomic percent (at %) | | | | | | Contact |
|---|---|---|---|---|---|---|---|---|---|---|---|---|
| | NbC | Ni | Mo₂C | WC | TiC | Nb | C | W | Mo | Ti | Ni | angle, θ |
| Sample | (wt %) | (wt %) | (wt %) | (wt %) | (wt %) | (at %) | (at %) | (at %) | (at %) | (at %) | (at %) | (°) |
| A | 67.6 | 18.6 | 0 | 13.8 | 0 | 34.1 | 42.7 | 4.2 | 0 | 0 | 19.0 | 140 |
| B | 76.2 | 19.6 | 1.9 | 0 | 2.3 | 33.4 | 46.3 | 0 | 1.0 | 2.1 | 17.3 | 57 |
| C | 77.6 | 20.4 | 2.1 | 0 | 0 | 40.0 | 42.3 | 0 | 1.1 | 0 | 19.6 | 19 |
| D | 73.2 | 22.7 | 4.1 | 0 | 0 | 35.1 | 40.7 | 0 | 2.3 | 0 | 21.9 | 26 |
| E | 72.9 | 19.6 | 7.5 | 0 | 0 | 35.1 | 41.7 | 0 | 4.2 | 0 | 19 | 5 |
| F | 70.8 | 13.5 | 11.9 | 3.8 | 0 | 34.8 | 43.8 | 1.1 | 6.8 | 0 | 13.4 | 43 |
| G | 41.6 | 18.8 | 39.6 | 0 | 0 | 20.3 | 39.1 | 0 | 22.3 | 0 | 18.4 | 12 |

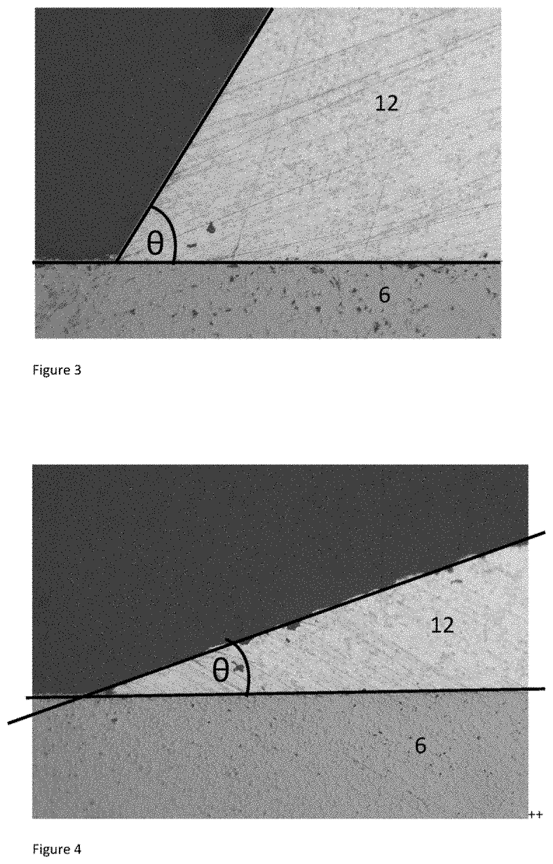

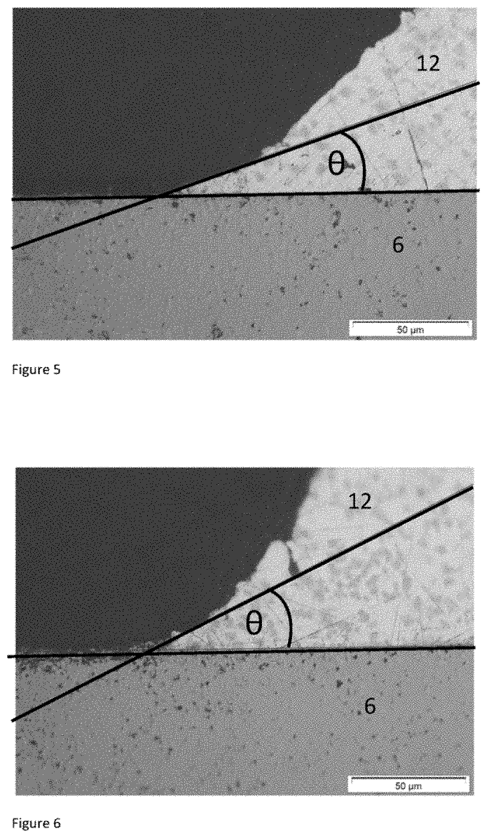

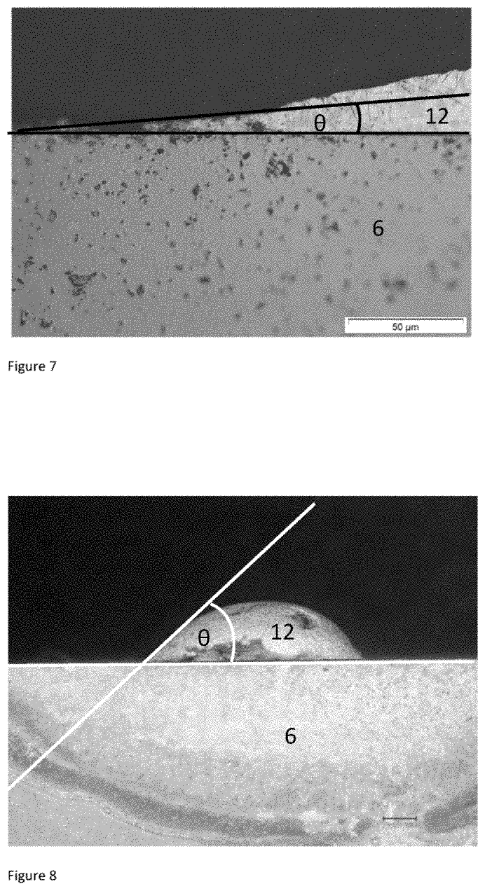

Optical microscopy images of the melted braze alloys were taken and the contact angles measured as shown in FIGS. 2-8 for samples A-G respectively. As can be seen in the above table, if no molybdenum carbide is added to the niobium carbide based cermet, the contact angle is >90° and is therefore not wetted. However, when even a small amount of molybdenum carbide is added to the composition, the contact angle significantly drops below 90° and good wetting is achieved. The lowest contact angle achieved was when 4.2 at % of Mo was incorporated in the sintered sample.

It should also be noted that when a WC based cemented carbides with either a cobalt or nickel metallic binder is brazed using a silver based braze alloy, the contact angle of the melted braze alloy is less than or equal to 90° even without any further additions to the composition, Mo or otherwise, being required. This means that good wetting and brazeability is achieved without any further modifications to the cemented carbide composition being required.

If the quantity, in wt %, of molybdenum carbide added exceeds the quantity of nickel added then precipitations of molybdenum carbide in the hard phase were observed.

Additions of other carbides, such as WC, TiC, VC, Cr₃C₂ or ZrC, to the cermet part with a niobium carbide based hard phase and a nickel based metallic binder did not achieve the same effect. The positive effect of reducing the contact angle with the melted braze alloy is unique for Mo₂C.

1. A body comprising:
a cermet part comprising a niobium carbide based hard phase and a nickel based metallic binder;
a braze alloy; and
at least one other part to which the cermet part is to be brazed to,
wherein the cermet part comprises molybdenum in an amount of at least 0.5 atomic percent.

2. The body according to claim 1, wherein the molybdenum is present in an amount of at least 1.0 atomic percent.

3. The body according to claim 1, wherein the molybdenum content of the cermet part is no greater than 10.6 atomic percent.

4. The body according to claim 1, wherein the braze alloy is silver based.

5. The body according to claim 1, wherein the at least one other part is a cermet, a cemented carbide or a part comprising a steel.

6. A method of brazing a cermet part, the cermet part comprising a niobium carbide based hard phase and a nickel based metallic binder, to at least one other part, the method comprising:
providing a hard phase powder comprising more than 50 wt % niobium carbide based on the total amount of the hard phase powder;
providing a metallic binder powder comprising more than 50 wt % nickel based of the total amount of the metallic binder powder;
mixing the hard phase powder and the metallic binder powder with an organic binder to obtain a powder mixture;
milling the obtained powder mixture;
pressing the milled powder mixture;
sintering the pressed powder mixture to obtain a sintered cermet part;
providing a braze alloy; and
brazing the obtained sintered cermet part to at least one other part by using the braze alloy;
wherein milling comprises either adding a powder of molybdenum carbide or adding a powder of a molybdenum and a powder of carbon.

7. The method according to claim 6, wherein the weight percent of the molybdenum carbide or the combined weight percent of the molybdenum and the carbon added is less than the weight percent of nickel of the total powder mixture.

8. The method according to claim 6, wherein the combined weight percent of the nickel and the molybdenum carbide or the molybdenum and the carbon is between 6 and 35 weight percent of the total powder mixture.

9. The method according to claim 6, wherein the braze alloy is silver based.

10. The method according to claim 6, wherein the at least one other part is a cermet, a cemented carbide or a part comprising a steel.

11-15. (canceled)
